(19) United States
(12) Patent Application Publication
(10) Pub. No.: US 2017/0275048 A1
(43) Pub. Date: Sep. 28, 2017

(54) BOXES

(71) Applicant: Urban Outfitters Wholesale, Inc., Philadelphia, PA (US)

(72) Inventors: Edward F. Brogna, Philadelphia, PA (US); Daniel Kent, Philadelphia, PA (US)

(73) Assignee: Urban Outfitters Wholesale, Inc., Philadelphia, PA (US)

(21) Appl. No.: 15/079,718

(22) Filed: Mar. 24, 2016

(51) Int. Cl. B65D 5/66; B65B 25/20; G06Q 90/00; B65D 5/468; B65D 85/18; B65B 5/06; B65D 5/20

(52) U.S. Cl. CPC B65D 5/6605; B65B 5/06; B65B 25/20; B65D 5/2052; B65D 5/4608; B65D 85/187; G06Q 90/00

(57) ABSTRACT

A rectangular box, which may be a shoebox, has two lids each of which covers one side of the top of the box. The lids are hinged at the sides of the box and meet in the middle. Each lid has a skirt round its free edges. The skirts fit into notches in the ends of the box.

### FIELD OF THE INVENTION

The invention relates to boxes for the storage and/or shipping of goods, and especially to a shoebox.

### BACKGROUND

It is well known to store and ship goods, including shoes, in rectangular boxes with lids. One common type of shoebox has a separate lid that lifts off. The lid has a skirt around all four sides that fits round the outside of the box body. A disadvantage of this type of lid is that, when it is removed, a place must be found to put the lid, and the lid may easily be dropped, damaged, or interchanged with the lid of another shoebox.

Another common type of shoebox has a lid that is hinged along one side of the box body, and has a skirt around the other three sides. A disadvantage of this type of lid is that when the box is taken from the shelf, about half the time the box will be held with the hinge at the front, and will have to be turned round. Even when the box is the correct way round, the large flap of the open lid can be inconvenient.

There is therefore a need for a better shoebox.

### SUMMARY

According to an embodiment, there is provided a rectangular box having a box body with a bottom, two opposite sides, and two opposite ends. A pair of rectangular lids, each with two ends and two sides, are hinged along one of the lid sides to a respective one of the two opposite sides of the box body, and are dimensioned so that when closed they meet midway between the two opposite sides. Each lid has a downwardly extending skirt along three edges, at the ends and at the meeting sides. At the ends of the lid, the skirts fit over the outsides of the box body ends. At the meeting sides of the lids, when the lids are closed the skirts substantially abut face to face. The box body ends are provided with notches through which the meeting side skirts pass.

With that embodiment, it is possible to open and close one lid at a time or both lids. The user thus has a choice to expose the whole interior and contents of the box, or only half the interior and contents of the box. That is particularly appropriate for a shoebox, where a pair of shoes are often packed side-by-side, and for an initial examination only one shoe of the pair may be needed. The other lid can then remain closed, so that the other shoe remains fully protected within the box, and the space required for the open box is reduced compared to a conventional box with a single lid.

The notches in the box body ends may be of non-uniform width, having a first portion near their open ends, at the top edge of the box body end, that is narrower than the combined thickness of the two lid skirts, to provide a gripping action, and a wider lower portion. The skirts may also be of non-uniform thickness, for example, by having a lip folded back over part of the height of the skirt, to form a step that catches under the narrower first portions of the notches.

The entire box, including the lids, may be formed from a single sheet of cardboard or other suitable material, cut and folded, with or without the use of adhesive. A design not requiring the use of adhesive may be advantageous in some circumstances, because it can be manufactured in one plant, and shipped in the form of flat sheets cut to shape and pre-creased along fold lines. The box can then be folded up and assembled in a different plant where it is to be filled with shoes or other goods, without requiring special machinery, and without the mess and complication that adhesive would cause. There may also be the possibility of disassembling the box without damaging it, and storing the box flat for future use. Alternatively, an assembly with adhesive may be stronger and more rigid, which may be advantageous in other circumstances.

According to another embodiment, there is provided a method of packaging shoes, comprising placing a pair of shoes side by side in the above-mentioned box, with a longest dimension of each shoe generally in a direction form one said end panel to the other said end panel.

According to another embodiment, there is provided a method of selling shoes, comprising providing a box with a pair of shoes within it as described above, with the lids in the closed position, opening only one of the lids, removing only the shoe within the side of the box corresponding to the opened lid, and displaying that shoe to a potential customer.

According to a further embodiment, there is provided a blank for the above-mentioned box.

### BRIEF DESCRIPTION OF THE DRAWINGS

The above and other aspects, features, and advantages of the present boxes may become apparent from the following more particular description, presented in conjunction with the following drawings, wherein:

FIG. 1 is a perspective view of a shoebox.

FIG. 2 is a plan view of a cut blank for forming the shoebox of FIG. 1.

FIG. 3 is a plan view of a cut blank for an alternative shoebox.

### DETAILED DESCRIPTION

A better understanding of various features and advantages of the present invention will be obtained by reference to the following detailed description of embodiments the invention and accompanying drawings, which set forth illustrative embodiments that utilize particular principles of the invention.

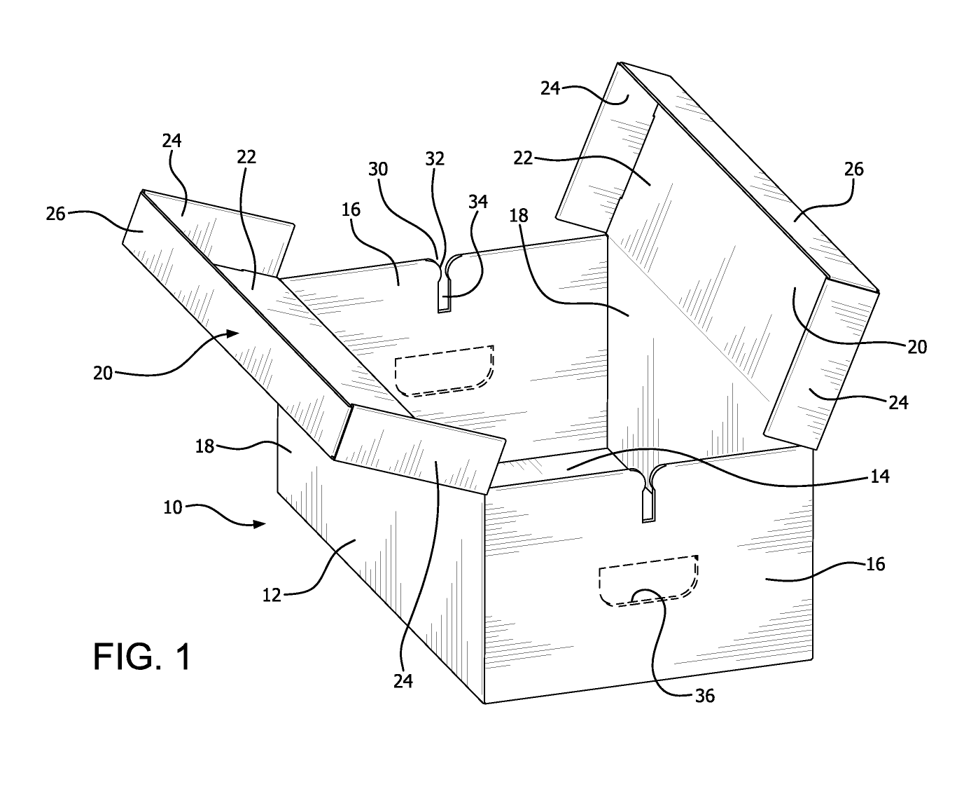

Referring to the accompanying drawings, and initially to FIG. 1, one form of shoebox, indicated generally by the reference numeral 10, comprises a rectangular box body 12, formed of a bottom 14, two ends 16, and two sides 18. Two lids 20 are each hinged to the box body 12 along the top edge of one of the two sides 18. Each lid 20 preferably extends the full length of the box body 12, and preferably half the width, so that when the lids 20 are closed they meet substantially in the middle without overlapping. Each lid 20 has a lid panel 22 that, when the lid is closed, covers approximately half the top of the box body 12, and has skirts that when the respective lid is closed extend downwards (that is to say, in the direction towards the bottom 14 of the box body 12). At the ends of the lid panels 22 are end skirts 24 that, when the lid is closed, closely overlie the outsides of the box body ends 16.

Along the sides of the lid panels 22 distal (laterally inward) from the box body sides 18 are side skirts 26 that, when both lids 20 are closed, lie substantially face to face inside the lids 20. The side skirts 26 serve to support and stiffen the lid panels 22, and prevent the lid panels 22 from sagging. That both improves the appearance of the closed box 10 and makes it easier to stack boxes 10.

The end and side skirts 24 and 26 are preferably joined together at the corners for greater strength and stiffness. To accommodate the joined corners, notches 30 are provided in the box body ends 16, through which the skirts 26 pass. Each notch 30 is preferably provided with a narrower portion 32 near the top edge of the box body end 16 and a wider portion 34 extending downwards below the narrower portion 32. The overall length of the notch 30 is slightly greater than the height of the skirt 26. The width of the narrower portion 32 is preferably slightly less than the combined thicknesses of the two skirts 26, and the width of the wider portion 34 is slightly more than the combined thicknesses of the two skirts 26. When the lids 20 are closed, the narrower portions 32, thus, grip the skirts 26, tending to hold the lids closed. Since the angular motion of the lid will cause the leading edge of side skirt 26 to press into the narrower portion of the notch 30 as the lid is closed, the preferred embodiment includes a wider portion 34, so that the closing of the lids is not hindered by the skirts 26 binding on the sides of the notch 30.

Cutouts 36 may be provided in the ends 16 of the box body 12 for hand holds, to make it easier to carry the box 10 and/or to pull the box 10 off a shelf.

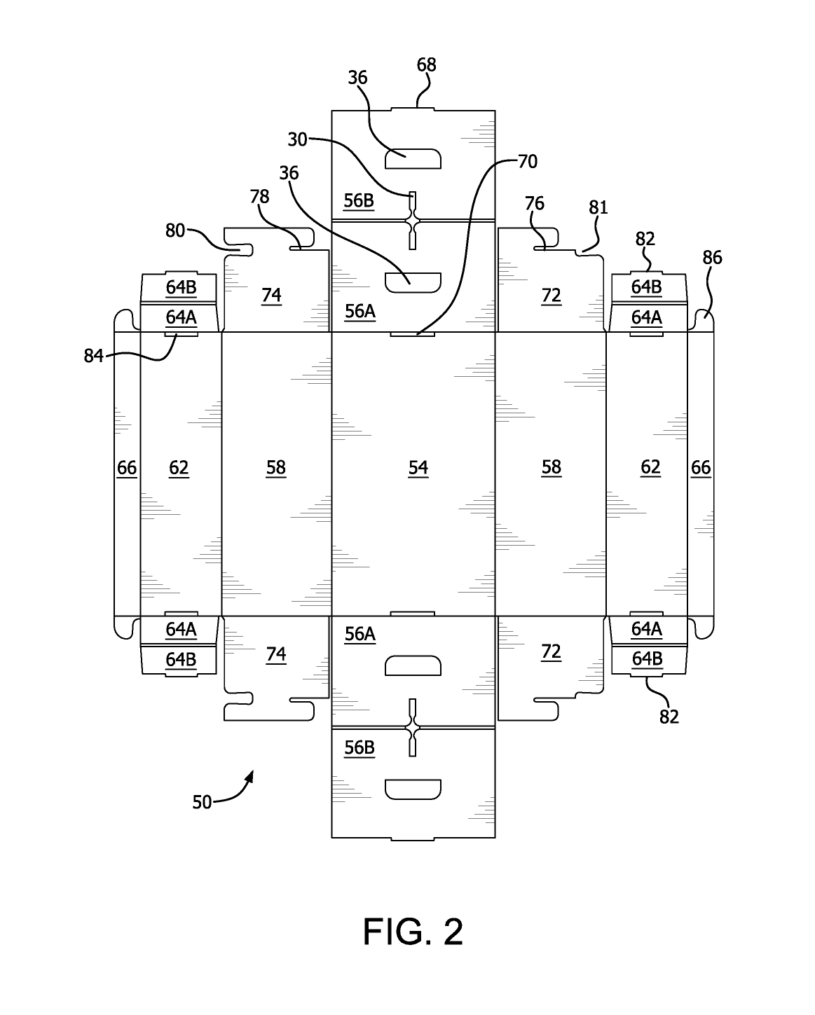

Referring now also to FIG. 2, one form of blank 50 for the shoebox 10 comprises a flat sheet of cardboard or other suitable material, cut to shape and pre-creased with fold lines. The term “hinged” is used when referring to the blanks as meaning the pre-creased fold lines about which two panel portions may be bent or folded during assembly.

A rectangular panel 54 is provided to form the box body bottom 14. On the two opposite side edges of the bottom panel 54 are rectangular panels 58, which form the box body sides 18, that are hinged at fold lines. On the outer side edges of the side panels 58 are hinged rectangular panels 62 which form the lid panels 22. On the outer side edges of the lid panels 62 are hinged rectangular strips 66 which form the lid skirts 26.

On each end of the bottom panel 54 is hinged an outer end panel 56A, which is as long, in the direction towards and away from the bottom panel 54, as the side panels 58 are wide. On the distal end of each outer end panel 56A is hinged an inner end panel 56B. The panels 56A and 56B are hinged together preferably by a double fold line or wider fold line, so that when the inner end panel 56B is folded in over the outer end panel 56A, they will lie parallel with a narrow space between them, the purpose of which is explained below.

A projecting tab 68 is fanned in the distal edge of each inner end panel 56B, and a matching slot 70, with a width equal to the thickness of the material from which blank 50 is formed, is cut out of a portion of the bottom panel 54 along the hinge of outer end panel 56A. The hand hold cutouts 36 are cut out of both the outer end panels 56A and the inner end panels 56B. The notches 30 are cut out of a portion of both the outer end panels 56A and the inner end panels 56B at the middle of the double hinge line where the end panels meet, with the cutout extending from one panel to the other through the double hinge line.

Mounting flaps 72 and 74 are hinged to the ends of side panels 58. One mounting flap 72 and one mounting flap 74 are provided at each end of blank 50. As shown, mounting flaps 72 are hinged along opposite edges of one side panel 58, and mounting flaps 74 are hinged to opposite edges of the other side panel 58, but that is not essential. The length of the mounting flaps 72, 74, in the direction towards and away from the side panels 58, is slightly more than half the width of the bottom panel 54 in the direction from one side panel 58 to the other. Each mounting flap 72, 74, has a slot 76, 78 respectively, parallel to the fold line with the side panel 58 and at a distance from the side panel 58 equal to half the width of the bottom panel 54. The slots 76 in the mounting flaps 72 extend from the side closer to the adjacent lid flap 62, and are closed at the end nearer the end panel 56A. The slots 78 in the mounting flaps 74 extend from the side nearer the end panel 56A, and are closed at the other end. The closed ends of the slots 76, 78 are approximately the same distance from the end panel 56A. The corner of each mounting flaps 74 furthest from the bottom panel 54 has a wider second slot 80 aligned with slot 78. The corner of each mounting flaps 72 furthest from the bottom panel 54 has a wide cutout 81 from the opening of slot 76 to the side of flap 72.

At the ends of the lid panels 62 are hinged outer end skirt strips 64A, to which are hinged, preferably by double hinges or wider hinges, inner end skirt strips 64B. Each of the end skirt strips 64A, 64B is the same width as the side skirt strips 66. A projecting tab 82 is formed in the distal edge of each inner end skirt strip 64B, and a matching slot 84, with a width equal to the thickness of the material from which blank 50 is formed, is cut out of the lid panel 62 along the hinge to outer end skirt strip 64A. An additional tab 86 is formed on each end of each side skirt strip 66.

To assemble the blank 50 into a box 10, first the mounting flaps 72, 74 are folded up perpendicular to the plane of the side panels 58, then the side panels 58 are folded up perpendicular to the bottom panel 54. The slots 76, 78 in the mounting flaps 72, 74 are fitted into each other to hold the mounting flaps 72, 74 at each end together. The outer end panels 56A are folded up against the outsides of the joined mounting flaps 72, 74, the inner end panels 56B are folded over and down against the insides of the joined mounting flaps 72, 74, and the tabs 68 are tucked into the slots 70. The double hinges between the outer end panels 56A and the inner end panels 56B provided the space needed to accommodate the thickness of the joined mounting flaps 72, 74. It will be seen that the wider slots 80 in the mounting flaps 72, 74 prevent the mounting flaps obstructing the notches 30.

The lids 20 are assembled by folding up the outer end skirt strips 64A, folding the inner end skirt strips 64B over, and tucking the tabs 82 into the slots 84. The side skirts 66 may then be folded up and the additional tabs 86 may be tucked in between the outer and inner end panels 56A and 56B. Alternatively, the side skirts 66 and the additional tabs 86 may be folded first, and the inner end panels 56A may be wrapped round the additional tabs 86.

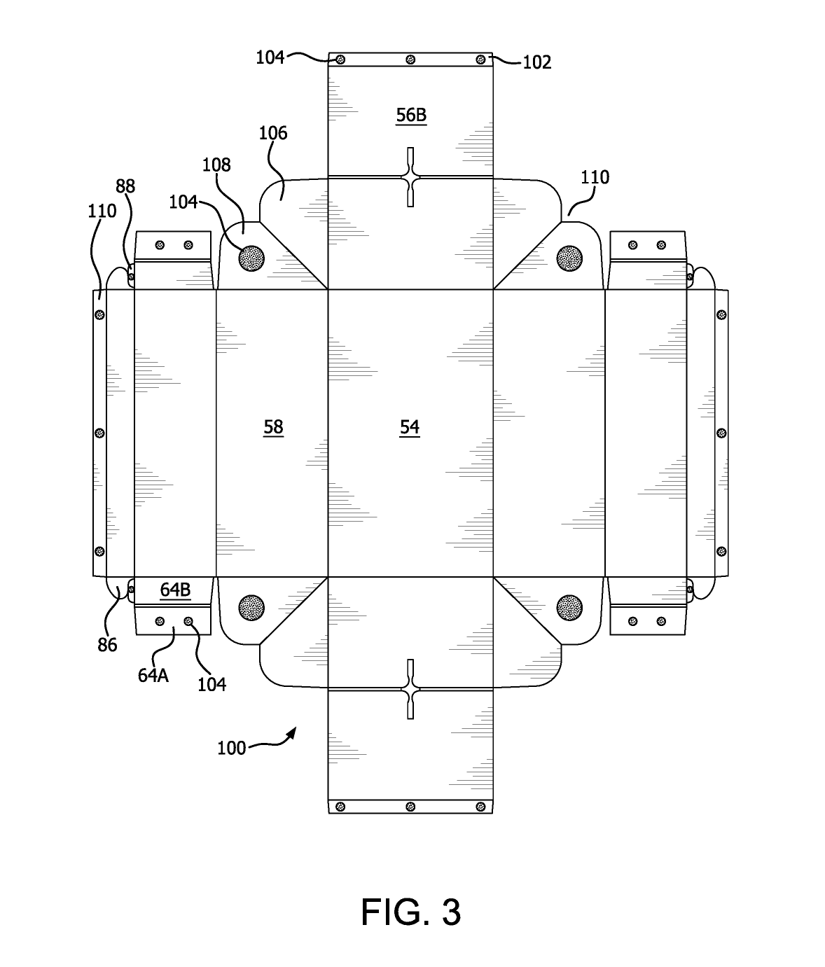

Referring now also to FIG. 3, the second form of blank 100 is largely similar to that shown in FIG. 2, and in the interests of conciseness only the differences will be described. It is further to be understood that a blank combining some of the features of blank 50 shown in FIG. 2 and some of the features of blank 100 shown in FIG. 3 is within the scope of the present disclosure.

Instead of the tab 68 and slot 70, the inner end panel 56B is provided with a flap 102 that is attached to the inside of bottom panel 54 by adhesive. In FIG. 3, the adhesive is shown in the form of spots 104 of glue, but other forms and patterns of adhesive may be substituted.

Instead of the mounting flaps 72, 74, a pair of flaps 106, 108, hinged to both the side panel 58 and the outer end panel 56A, and hinged to each other at 45 degrees, are provided. The flaps 106, 108 fold together inside the box when the side panels 58 are folded up, and may be tucked in between the outer and inner end panels 56A, 56B. For greater strength and stability, the flaps 106, 108 may be attached to each other, or to one of the outer and inner end panels 56A, 56B, by adhesive 104. The outer corners of the flaps 106, 108 are notched at 110 for the same reason as the wide slots 80 in FIG. 2.

Instead of the tab 82 and slot 84, the inner end lid skirt strips 64B are held down by adhesive 104 to the outer end lid skirt strips 64B. The adhesive is offset to the side nearer the box body sides 58, to leave an open pocket for the additional tab 86. Alternatively, or in addition, an additional flap 88 on the outer end lid skirt strip 64B may be attached by adhesive 104 to the outside of the side lid skirt 26.

An additional lip 110 may be provided along the outer edge of the lid side skirt strip 66. The lip 110 is narrower than the lid side skirt strip 66, and is folded back and glued to the inside of the lid side skirt strip 66. That forms a thicker part of the lid side skirt 26 that fits into the wider part 34 of the notch 30 in the box body end panel 16. The thicker part is dimensioned to catch under the narrower part 32 of the notch 30, holding the lids 20 closed with a slight snap action.

The preceding description of a presently contemplated best mode of practicing the invention is not to be taken in a limiting sense, but is made merely for the purpose of describing the general principles of the invention. Variations are possible from the specific embodiments described. For example, although the panels 16 have been referred to as “ends” and the panels 18 have been referred to as “sides,” the box 10 may be square, or the panels 18 to which the lids 20 are hinged may be shorter than the panels 16 with the notches 30.

Although for convenience of description terms of orientation such as “bottom 14” have been used, the box (especially when empty) may be kept, stored, carried, and used in any convenient orientation.

The hand hold cutouts 36 are shown in the end panels 16, 56A, 56B in FIGS. 1 and 2, and omitted from FIG. 3. Those or other cutouts may be provided in the end panels 16, the side panels 18, both, or neither, and may be provided in one end or side and not in the opposite end or side.

Although specific embodiments have been described, the skilled person will understand how features of different embodiments may be combined. The full scope of the invention should be determined with reference to the claims.

1. A box, comprising:
a bottom panel, first and second opposite side panels, and first and second opposite end panels, together forming a cuboidal box body with an open top;
rectangular first and second lid panels, each having first and second opposite ends and first and second opposite sides and hinged at the first side to a respective one of the first and second side panels, each extending from one said end panel to the other said end panel, and having a width between its first and second opposite sides substantially equal to half the width of the box body between its first and second opposite side panels; and
end lid skirts along the ends of each lid panel and side lid skirts along the second side of each lid panel, projecting from each of said first and second lid panels generally perpendicular to the respective lid panel and joined at the corners between the ends and second sides of each lid panel, said skirts so positioned that when said lids are in a closed position in which said lid panels cover said top of said box body the end lid skirts overlie the box body end panels and the side lid skirts are within the box;
each of said box body end panels being provided with a notch through which said side lid skirts pass.

2. The box according to claim 1, wherein each said notch has a closed end portion wider than a sum of thicknesses of the two side lid skirts, and a neck portion between the closed end portion and an open end of the notch narrower than the sum of thicknesses of the two side lid skirts.

3. The box according to claim 1, wherein each side lid skirt has a first portion adjacent to said lid panel and a second portion thicker than said first portion distal from said lid panel, and wherein each said notch has a closed end portion wider than a sum of thicknesses of the distal portions of the two side lid skirts, and a neck portion between the closed end portion and an open end of the notch narrower than the sum of thicknesses of the distal portions of the two side lid skirts.

4. The box according to claim 3, wherein the neck portion of the notch is narrower than a sum of thicknesses of the first portions of the two side lid skirts.

5. The box according to claim 1, further comprising a pair of shoes side by side within said box, with a longest dimension of each shoe generally in a direction from one said end panel to the other said end panel.

6. A method of packaging shoes, comprising placing a pair of shoes side by side in a box according to claim 1, with a longest dimension of each shoe generally in a direction form one said end panel to the other said end panel.

7. A method of selling shoes, comprising:
providing a box according to claim 5 with said lids in said closed position;
opening only one of said lids;
removing only the shoe of said pair of shoes within a side of said box corresponding to said one of said lids; and
displaying said shoe to a potential customer.

8. A blank for a box, comprising:
a rectangular bottom panel, having first and second sides and first and second ends and having a first length and a first width;
first and second rectangular side panels, each having first and second sides and first and second ends and having the first length and a second width, and hinged at their first sides to respective ones of the first and second sides of the bottom panel along the first length;
first and second rectangular end panels, each having first and second sides and first and second ends and having the first width and a second length substantially equal to the second width, and hinged at their first ends to opposite ones of the first and second ends of the bottom panel along the first width;
the bottom panel, first and second side panels, and first and second end panels being foldable together to form a cuboidal box body with an open top;
rectangular first and second lid panels each having first and second opposite ends and first and second opposite sides and each having the first length and a third width substantially equal to half the first width, each hinged at the first side to the second side of a respective one of the first and second side panels along the first length;
rectangular side lid skirts each having first and second opposite ends and first and second opposite sides and having the first length and a fourth width, and hinged at the first side to the second side of a respective one of the first and second lid panels along the first length; and
rectangular end lid skirts, each having first and second sides and first and second ends and having the third width and a third length substantially equal to the fourth width, and each hinged at its first end to a respective one of the first and second ends of a respective one of the first and second lid panels along the third width;
each of said end panels being provided at a center of its second end with a notch having a depth at least equal to the fourth width.

9. The blank according to claim 8, wherein each said notch has a closed end portion wider than a sum of thicknesses of the two side lid skirts, and a neck portion between the closed end portion and an open end of the notch narrower than the sum of thicknesses of the two side lid skirts.

10. The blank according to claim 9, further comprising rectangular side lid skirt lips, each having first and second ends and first and second sides and each having the first length and a fifth width less than the fourth width and less than a depth of said closed end portions of said notches, and hinged along their first sides to the second sides of respective ones of said side lid skirts along the first length, and wherein said closed end portions of said notches are wider than a sum of thicknesses of the two side lid skirts and the two side lid skirt lips, and the notch neck portions are narrower than the sum of thicknesses of the two side lid skirts and the two side lid skirt lips.

11. The blank according to claim 9, wherein the notch neck portions and are wider than the sum of thicknesses of the two side lid skirts.
